(19) United States
(12) Patent Application Publication
(10) Pub. No.: US 2015/0114899 A1
(43) Pub. Date: Apr. 30, 2015

(54) Sieve Device for Separating and Removing Impurities from Sewage

(71) Applicant: Huber SE, Berching (DE)

(72) Inventor: Markus Lindl, Dietfurt (DE)

(21) Appl. No.: 14/526,589

(22) Filed: Oct. 29, 2014

(30) Foreign Application Priority Data
Oct. 29, 2013 (DE) 10 2013 111 915.8

(51) Int. Cl. B01D 33/04; B01D 33/50; B01D 33/46

(52) U.S. Cl. CPC B01D 33/04; B01D 33/461; B01D 33/50
USPC 210/391

(57) ABSTRACT

The present invention refers to a sieve device for separating and removing impurities (1) from sewage (2) with at least two endless drive elements running parallel to one another that can be driven with the help of a drive (3) in conveying direction (F), wherein the drive elements (4) are guided in each case over a lower redirecting area (5) and an upper redirecting area (6) along an orbit, wherein multiple sieve elements (8) extend, arranged adjacently to one another between the drive elements (4), and connected to the drive elements (4), wherein at least most of the sieve elements (8) have in each case a sieve surface (9) curved outward in a side view of the sieve device and wherein the sieve device, downstream from the upper redirecting area (6) in conveying direction (F), has a cleaning device (10) that the sieve elements (8) can pass through while they move along the orbit mentioned above in order to remove the impurities (1) held back by the sieve elements (8) of the sieve surfaces (9). According to the invention, it is suggested that the drive elements (4) and/or the sieve elements (8) are guided in each case along a guiding track (12) in the area of the cleaning device (10) with the help of guiding elements (11), in which case, in the side view mentioned above, the guiding track (12) has a section curved outward 13 (i.e. towards the cleaning device (10)) in the area of the cleaning device (10).

The present invention refers to a sieve device for separating and removing impurities from sewage with at least two endless drive elements running parallel to one another that can be driven with the help of a drive in conveying direction, wherein the drive elements are guided in each case along an orbit above a lower redirecting area and an upper redirecting area, wherein multiple sieve elements extend, arranged adjacently to one another between the drive elements and connected to them, wherein at least most of the sieve elements have in each case a sieve surface curved outward in a side view of the sieve device and wherein the sieve device has a cleaning device, which the sieve elements can pass through while they move along the orbit mentioned above in order to remove the impurities held back by the sieve elements of the sieve surfaces.

A generic sieve device is known, for example, from DE 10 2004 062 316 A1 and serves for separating impurities from sewage flowing into a sewer. To accomplish this, the device has two chains running parallel to one another between which, in turn, multiple adjacent sieve elements extend. The sieve elements have in each case a sieve surface curved outward, through which the impurities flowing in the sewage are held back. If the chains are moved along their orbit with the help of an electric motor, the impurities finally reach in conveying direction an area downstream from the upper redirecting area of the chains, and are loosened there from the sieve elements with the help of a brush in order to finally reach a collecting receptacle, such as a container, for example, via an ejection device. The sewage free of impurities passes through the sieve device and can be transported from there for further use.

The disadvantage of this is the fact that cleaning takes place in an area where the sieve elements are located on a straight section of the orbit. In this area, the sieve surfaces curved outward of the individual sieve elements form no flat surface but a sieve surface consisting of a succession of sieve valleys and sieve mountains. This, in turn, prevents the brush from being able to reach the sieve valleys fully to dean them if the distance to the sieve surfaces is too great. If, on the other hand, the above-mentioned distance is chosen to be so small that the brush can reach the entire sieve surface, then the brush bristles are immersed in the sieve mountain area of the sieve surface or their sieve openings. This will unavoidably wear out the brush, deteriorating it in the long term.

The task of the present invention is therefore to suggest a generic sieve device that allows reliable sieve surface cleaning without the risk of damaging the cleaning device.

The task is solved by a sieve device having the characteristics of patent claim 1.

According to the invention, the sieve device is thus characterized by the fact that the drive elements that guide the sieve elements along their orbit and/or the sieve elements themselves along a guiding track in the area of the cleaning device with the help of guiding elements, in which case, in the side view of the sieve device (i.e. with a view to a plane that runs parallel to the two elements formed by the drive elements), the guiding track has a section curved outward in the area of the cleaning device, i.e. in the direction of the cleaning device. In other words, according to this invention, the sieve elements in the area of the cleaning device (which is preferably executed as a driven cleaning brush) do not move on a straight section of the orbit. Rather, there are guiding elements arranged in the area of the cleaning device that define a section curved outward of the guiding track. Seen in conveying direction, the above-mentioned section of the guiding track is located after an upper redirecting area of the orbit, in which case the drive elements (e.g. two redirecting chains running parallel to one another whose two sides are in each case connected to the individual sieve elements) can be guided and driven, for example, with the help of Iwo gear wheels running parallel to one another in the upper redirecting area.

The section curved outward guides the sieve elements in conveying direction along a guiding track curved outward in an area downstream from the upper redirecting area. As a result of this, the sieve elements do not to go past the cleaning device in a straight line. Rather, the curved guiding section causes the gap separating the sieve surface from the sieve element being led past the cleaning device and the section of the cleaning device that makes contact with the sieve surface to remain largely constant when passing the sieve element. In this way, the cleaning device can clean almost the entire sieve surface of the individual sieve elements that points outwards, without the sections of the cleaning device making contact with the sieve surfaces (for example, the outer sections of the bristles of a cleaning brush) having to be immersed excessively in the sieve mountains of the sieve surfaces or the sieve openings placed there. This reliably prevents damage to the cleaning device.

In the final analysis, the sieve device also has preferably two drive elements in form of two endless chains running parallel to one another and guided along an endless track. Mounted on the endless chains there are, in turn, multiple sieve elements extending preferably perpendicularly to the conveying direction of the chains between them and led along an orbit by the chains. On the other hand, in turn, a cleaning device is provided (preferably in form of a rotating cleaning brush) in one of the upper redirecting areas of the chains, in an area downstream from conveying direction, that moves against the conveying direction of the chains, for example, during operation. Finally, a guiding track with a section curved outward has been provided in one section of the orbit of the chains downstream from the upper redirecting area.

It is furthermore advantageous when the section curved outward transitions, preferably directly, into a section curved inward in conveying direction. This can improve even more the cleaning of the respective sieve surfaces. In this way, the section curved inward can lengthen the guiding track curved outward. If the section curved inward would not exist, then the sieve elements would once again be redirected back to a straight guiding section after passing the guiding section curved outward, restricting the length of the section curved outward. Contrary to this, the section curved outward can be lengthened if, in conveying direction, it transitions into an guiding section curved inward that finally guides the conveying elements back to the subsequent straight-running orbit.

It is advantageous if, in the above-mentioned side view, the guiding track runs sigmoidally in the area of the cleaning device. In other words, the guiding section curved outward can transition immediately into the guiding section curved inward that, in turn, follows a straight section of the orbit in conveying direction. In this case, it is furthermore advantageous if the section curved outward and the section curved inward lie roughly on a circular arc when seen in a side view of the sieve device. In this case, the circular arc radius that follows the guiding section curved outward can be smaller or greater than the circular arc radius that follows the guiding section curved inward. It is also conceivable for both radii to be equally large.

It is also advantageous if the section curved inward of the guiding track and/or the section curved outward of the guiding track is downstream from the cleaning device in conveying direction. It can also be advantageous if the upper redirecting area, when seen in conveying direction, transitions into the guiding section curved outward, either directly or over a short straight section. This section can, in turn, transition (likewise directly or indirectly) into a guiding section curved inward, which can finally transition into a straight section of the orbit. The latter section can extend all the way to a lower redirecting area by redirecting the sieve elements running downward to an area of the orbit ascending obliquely. In this area, the sieve elements make contact with the dirty sewage and hold back the impurities that come to the top after being moved by the sieve elements. After passing through the upper redirecting area, the sieve elements are finally redirected by the guiding sections curved outward according to the invention and freed from impurities by the cleaning device, so that they can once again resume filtering the sewage after being redirected in the lower redirecting area.

It is additionally advantageous if the section curved outward of the guiding track in the above-mentioned side view is arranged at the level of the cleaning device adjacent to it. As a result of this, the section curved outward of the sieve surfaces is always located at the level of the cleaning device. If this is a rotating cleaning brush, then it can be placed in such a way that the outer tips of the cleaning bristles make contact with the sieve surface without being (too) immersed in the sieve openings of the sieve elements. This reliably prevents undesired wear of the above-mentioned bristles.

It is also advantageous if the section curved inward of the guiding track is arranged downstream from a straight running section of the hiding track in conveying direction. This section, in which the sieve elements move downwards when the sieve device is operating, can, in turn, run parallel to the section of the orbit of the sieve elements that extends along the inflow side between the upper and lower redirecting area and on which the sieve elements move upward.

It is especially advantageous if, in the side view mentioned above, the lowest point of the arch of the section curved outward and the lowest point of the arch of the section curved inward lie on different sides of an imaginary extension of the section running straight mentioned in the previous paragraph. In this case, the sieve elements are first redirected outward and then inward starting from the imaginary extension. Following this, a redirection towards the above-mentioned extension takes place, so that—after passing through the curved sections—the sieve elements are found once again on a straight orbit that finally transitions into a semi-circular track in the lower area of the sieve device, i.e. in the lower redirecting area. After passing the lower redirection area, the sieve elements finally follow a preferably oblique straight ascending section of the orbit by making contact with the sewage at least in the lower part of this section and accomplishing the desired holding back of the impurities.

It is likewise advantageous when a straight running section of the guiding track or a redirecting section of the upper redirecting area is arranged before the section curved outward of the guiding track. Thus, after passing through the upper redirecting area, the sieve elements can either be directly redirected by the guiding sections curved outward but it is also conceivable for the sieve elements to be guided along a straight guiding section after the redirecting area (as seen in conveying direction) and be redirected outward only subsequently to reach the cleaning device and make contact with it.

It is likewise advantageous if the drive elements are executed as endless drive chains that can be guided in each case with the help of guiding rollers along one of the guiding tracks when the sieve device is operating. In this case, the sieve elements are not guided directly; rather, the two sides of each element are connected to one of the drive chains running parallel. The drive chains are equipped, in turn, with the above-mentioned guiding rollers so they can be mounted alternatively on the sieve elements themselves too. In any case, it is advantageous if the guiding rollers are arranged inside, in channel-like guiding devices, for example, formed by the guiding elements separated correspondingly from one another. An especially low abrasion guidance of the sieve elements is made possible by the guiding rollers, in which case the guiding elements should be provided at least in the area of the guiding sections curved outward and/or inward.

It is additionally advantageous if the gap between the lowest point of the arch of the section curved outward and the lowest point of the arch of the section curved inward is 0.5 to 2 times, preferably 0.8 to 1.2 times, greater than the gap between two adjacent guiding rollers in conveying direction if these guiding rollers are in the area of a straight section of the guiding track. In this case, the redirecting of the sieve elements of the guiding section curved outward to the guiding section pointing inward takes place in a gap that corresponds approximately to the height of the sieve surfaces (the height is defined here as the spatial extension of the individual sieve surfaces in conveying direction).

It is advantageous if the guiding track is formed by guiding elements placed on both sides of the guiding rollers in the area of the arches. In this case, the guiding elements cause a two-sided guidance of the guiding rollers, wherein the guiding elements have guiding surfaces running parallel to the rotational axes of the guiding rollers. Furthermore, additional guiding areas extending perpendicularly to the rotational axes mentioned above for the lateral guidance of guiding rollers, i.e. a guidance on the sides of the guiding rollers facing away from the sieve elements, could be provided. The guiding elements and/or the guiding rollers can also be made from an abrasion-resistant plastic to allow easy manufacturing with low friction between guiding elements and guiding rollers.

Additional advantages are also gained if the guiding elements have guiding surfaces that face the guiding rollers and the mutual separation of these surfaces is preferably constant in the area of the arches. Here, the guiding areas run preferably parallel to the rotational axes of the guiding rollers, in which case the gap of the guiding surfaces should be slightly greater than the diameter of the guiding rollers.

It is furthermore advantageous if the cleaning device comprises one cleaning brush preferably fixed in place that can be driven with the help of a drive moving around a rotational axis, in which case the rotational axis runs preferably perpendicularly to the conveying direction and in which case the cleaning brush can be preferably driven in a rotational rotation that causes an opposite movement to the outwardly pointing brush sections making contact with the correspondingly adjacent sieve surface. In other words, the rotational direction of the cleaning brush is selected in such a way while the sieve device is operating that the brush sections making contact with the corresponding sieve surface move in opposite direction to the conveying direction of the sieve elements. In this case, the cleaning effect is particularly high.

Further advantages of the invention are described in the following embodiments, which show:

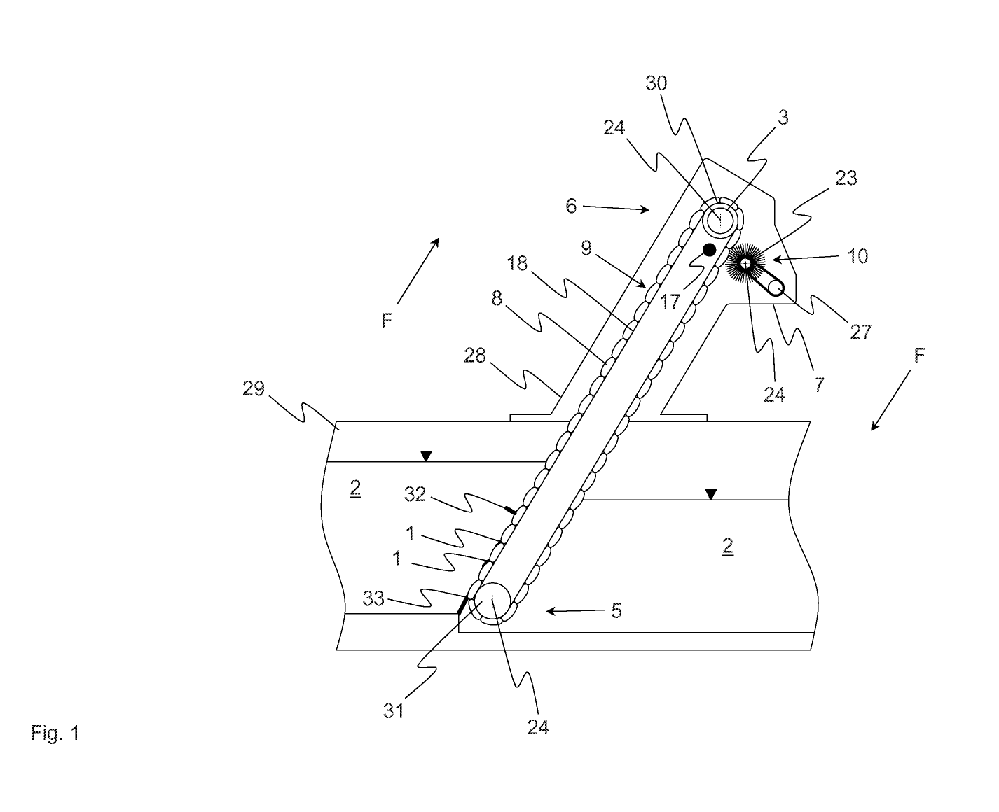

FIG. 1 the above-mentioned side view of a generic sieve device,

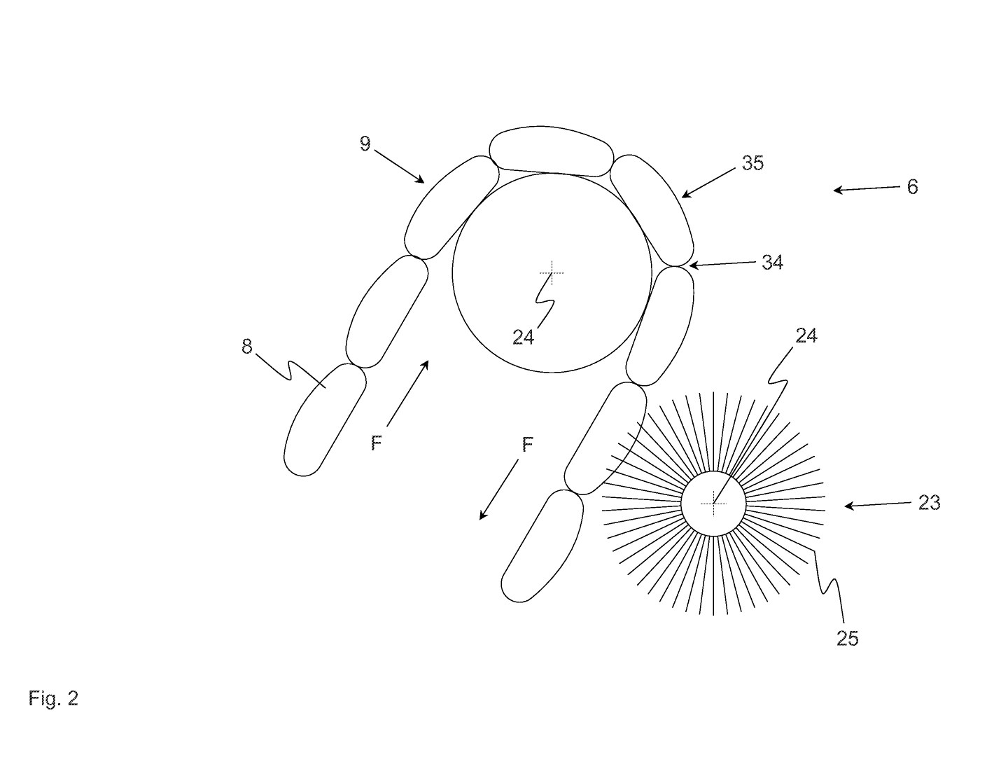

FIG. 2 the upper redirecting area of the sieve device from FIG. 1,

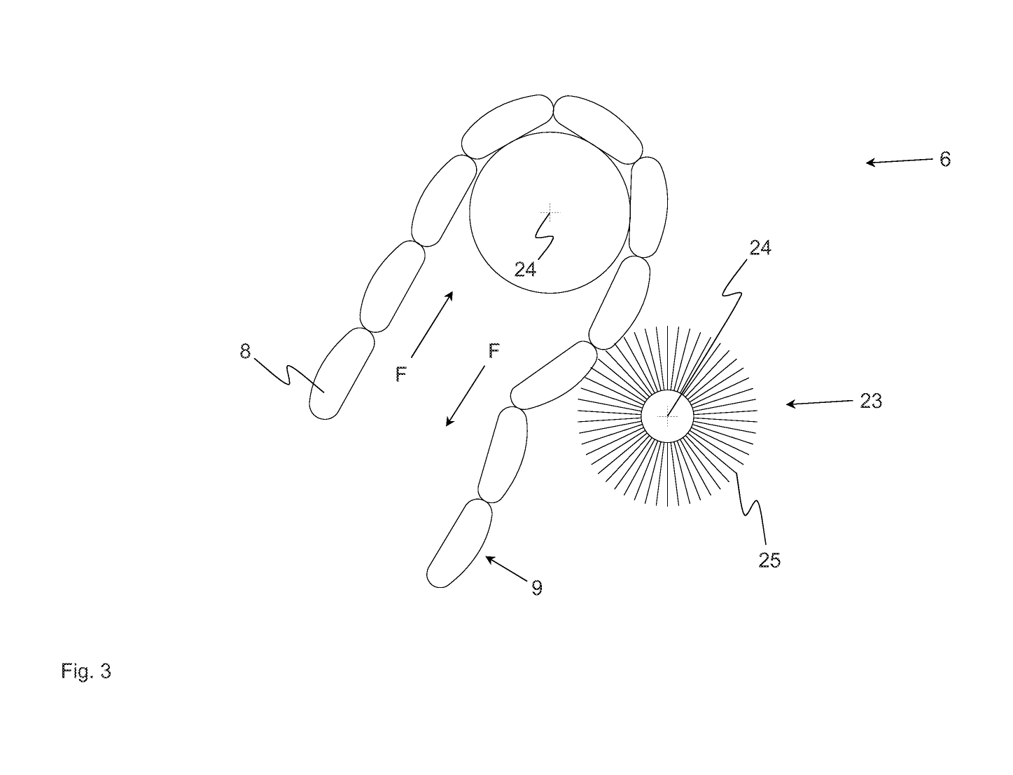

FIG. 3 the upper redirecting area of a sieve device according to the invention,

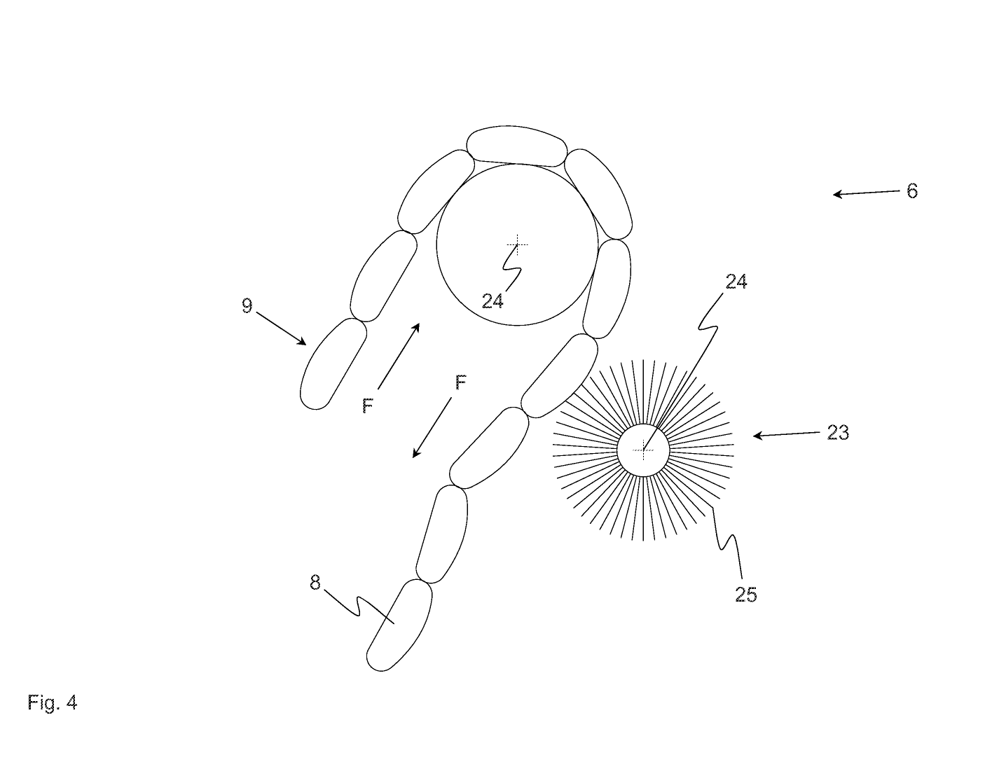

FIG. 4 the upper redirecting area of the sieve device from FIG. 3 with a changed position of the sieve elements with regard to FIG. 3,

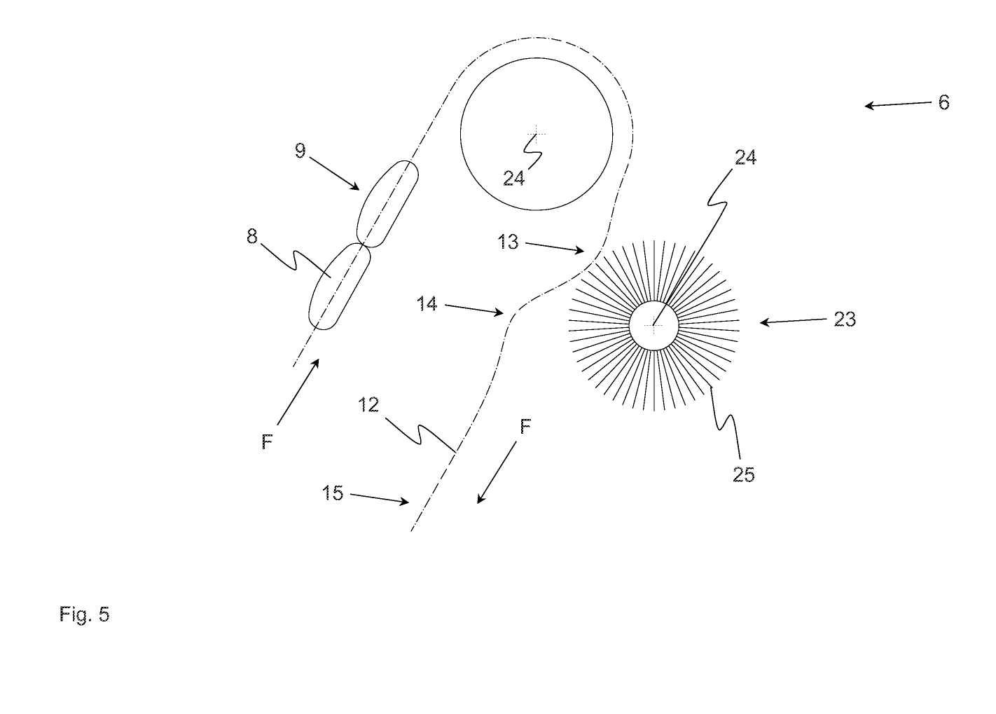

FIG. 5 the guiding track of the sieve elements from FIGS. 3 & 4,

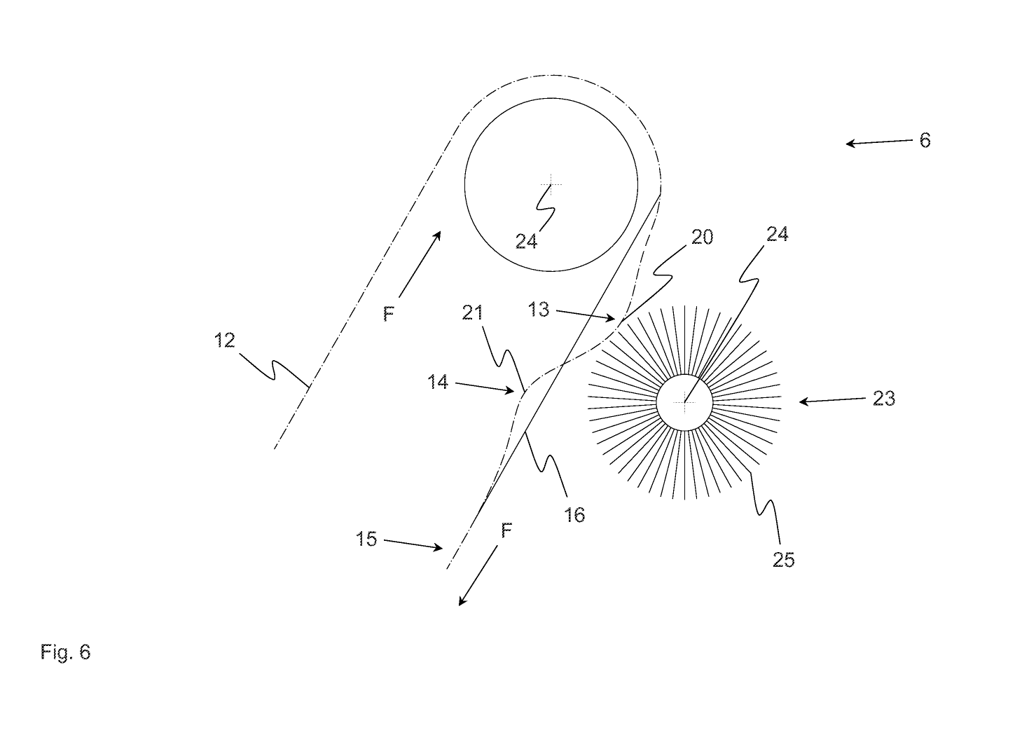

FIG. 6 a slightly changed view of the one shown in FIG. 5,

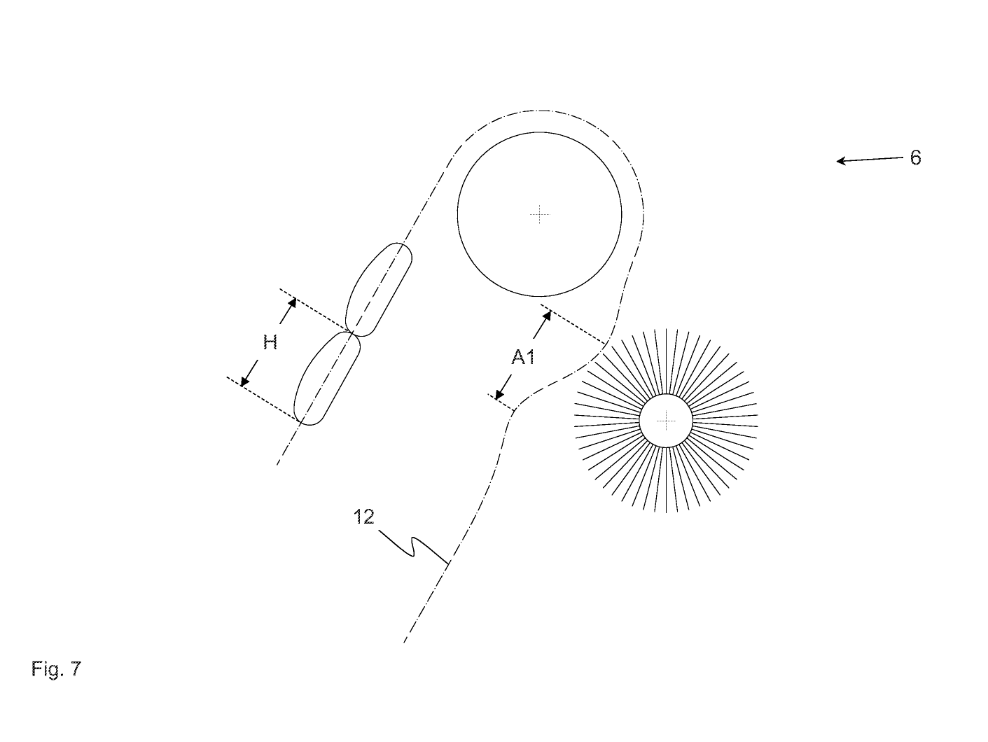

FIG. 7 two additional characteristics of the view according to FIG. 6,

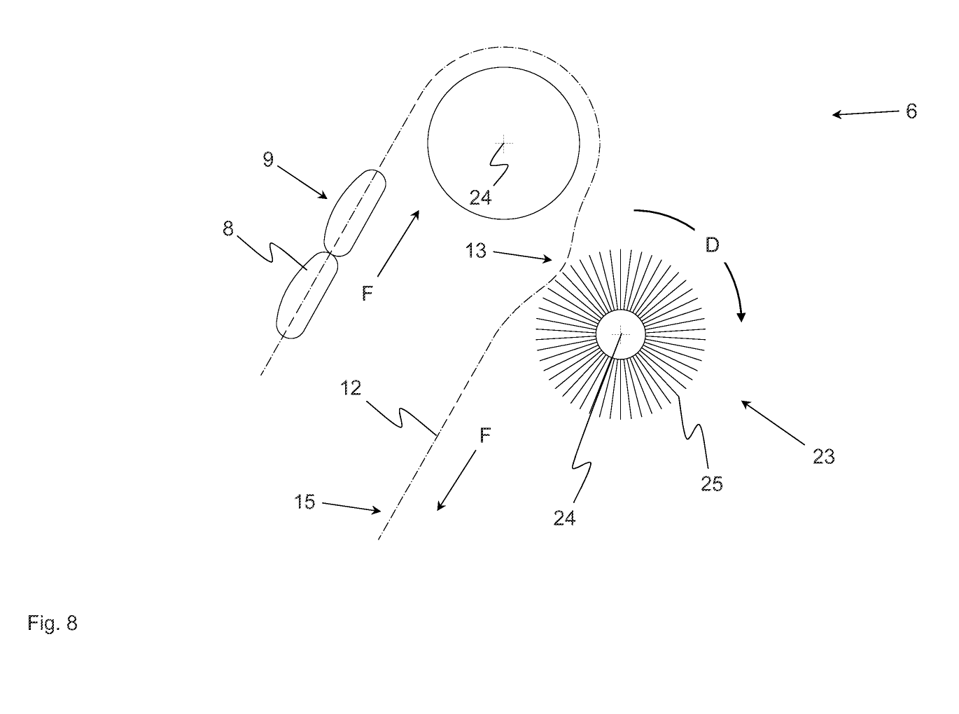

FIG. 8 the guiding track of the sieve elements of another sieve device according to the invention, and

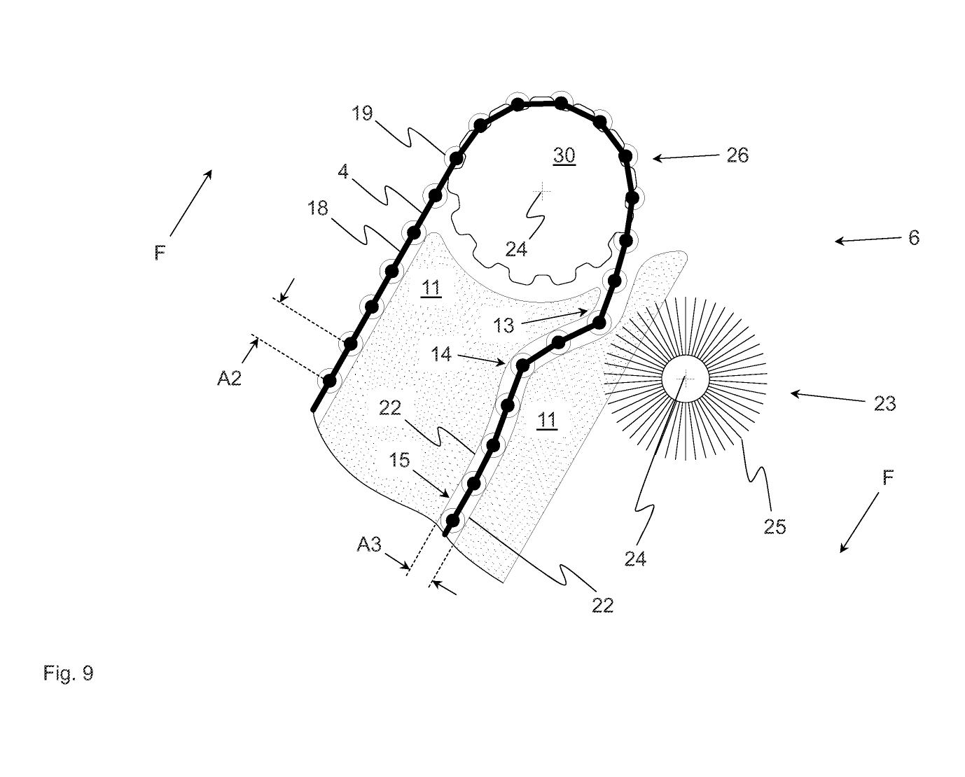

FIG. 9 the upper redirecting area of an additional sieve device according to the invention.

To begin with, it must be mentioned that figures showing several parts in the same way (e.g. sieve elements 8), sometimes identify only one of them with reference signs to ensure good clarity. Likewise, not all parts are identified with reference signs in all figures (see FIG. 7, for example). Generally, parts drawn in the same way are also understood to be identical, so that with regard to the omitted reference signs in a figure, reference can be made to the remaining figures.

FIG. 1 shows a generic sieve device placed in a public sewer 29. In principle, the sieve device has one carrier structure 28 connected, for example, to a corresponding foundation above the sewer 29. Furthermore, the sieve device comprises two drive chains 18 that, perpendicularly to the sheet plane, run parallel to one another (for this reason, only one of the drive chains 18 is visible). Multiple sieve elements 8, running perpendicularly to the sheet plane, extend between the two drive chains 18, and connect with the drive chains 18 on both of their sides and have, in each case, a sieve surface 9 curved outward and a sieve surface 9 curved inward (see, for example, FIG. 2 for their basic form). The sieve surface 9 can be formed, for example, by a correspondingly arched metal surface having multiple sieve openings.

While the sieve device is operating, the drive chains 18 are guided on an endless orbit, in each case through two upper gear wheels 30 arranged parallel to one another and two lower gear wheels 31 likewise arranged parallel to one another that can be rotated around the corresponding rotation axes 24, on an endless orbit, in which case they can be driven with the drive 3 of the drive chains 18 with the help of a drive 3 (e.g. an electric motor) arranged in an upper redirecting area 6, for example.

When the sieve device is operating, the sieve elements 8 (arranged on the left side in FIG. 1) are placed on the inflow side of the sewage 2 flowing in the sewer 29, in which case a seal 33 can be placed in the lower redirecting area 5 and, in case of need, also in the lateral area of the sieve device, in order to seal the sieve device from the sewer 29 and prevent impurities 1 from passing through these areas.

During the sieve process, the sewage 2 can pass through the sieve openings of the sieve elements 8, while the impurities 1 being transported by the sewage 2 are held up by the sieve elements 8 (in addition to the sieve elements 8, one or several cleaning rakes 32 can be provided so larger impurities 1 can also be safely removed from the sewer 29). The sieve elements 8, and therefore the held-up impurities 1 too, finally reach—after passing through the upper redirecting area 6—the area where there is a cleaning device 10 (for example, a rotating cleaning brush 23 moved with the help of a brush drive 27), with which the impurities 1 are removed from the sieve surfaces 9 of the sieve elements 8 (in which case a spray nozzle 17 or spray nozzle bar can be provided to spray water from the inside to the outside through the sieve surfaces 9 to aid cleaning).

The impurities 1 detached from the sieve surfaces 9 finally reach the exterior (for example, through an ejection device 7) and can be collected, for example, in a corresponding collecting container (not shown).

FIG. 2 shows the significant disadvantage of the sieve devices known to date. As can be clearly seen in the figure, the cleaning brush 23 must be placed relatively close to the sieve elements 8 so the valleys 34 (formed from the total sieve surface from the individual sieve surfaces 9) available in the contact area of the two sieve elements 8 can be reached and cleaned accordingly. This, in turn, unavoidably results in the fact that the outward-pointing brush sections 25 of the cleaning brush 23 project into the sieve openings of the sieve surfaces 9 in the area of the mountains 35 of the sieve surfaces 9 and this leads in the long run to an excessive wear of the cleaning brush 23.

To act against this disadvantage, the invention suggests that the drive elements 4 of the sieve elements 8—which are preferably provided in form of the above-mentioned drive chains 18—and/or the sieve elements 8 themselves should be guided in each case on a guiding track 12 with the help of guiding elements 11 in the area of the cleaning device 10, in which case the guiding track 12 has a section curved outward 13 (i.e. in the direction of the cleaning device 10) seen in the lateral view shown in FIG. 1. Thus, the sieve elements 8 pass through the cleaning 10 device not as typically occurs in the state of the art, namely on a guiding track 12 running straight. Rather, in the area of the cleaning device 10, it has a section curved outward 13 that causes the sieve elements 8 to be redirected towards the cleaning device 10.

The advantage can be clearly seen in the total view shown in FIGS. 3 and 4 compared to FIG. 2 (although FIGS. 3 and 4 show the same upper redirecting area 6, both figures differ in that the sieve elements 8 in FIG. 4 were moved a bit towards the conveying direction F starting from FIG. 3). As is evident in the figures, the section curved outward 13 causes the sieve elements 8 to deflect towards the cleaning brush 23, so that the latter can make contact with the entire sieve surface 9 of the individual sieve elements 8 without having to be immersed into the sieve openings in the area of the mountains 35 mentioned above. In other words, the cleaning brush 23 makes contact only through the brush sections 25 facing outward and, when doing so, preferably only superficially with the sieve surfaces 9. Ultimately, the entire sieve surface 9 of each sieve element 8 can be reliably cleaned without causing excessive wear of the cleaning brush 25 bristles.

The path of an advantageously executed guiding track 12, on which the sieve elements 8 are guided in their orbit in the area of the cleaning device 10, is shown schematically in FIG. 5. As can be seen in this figure, the guiding track 12 following the upper redirecting area 6 has a section curved outward 13, which in an advantageous further development of the invention transitions directly (or by interposition of a straight section) into a section curved inward 14 (for clarity purposes, FIG. 5 shows only two sieve elements 8; however, the arrangement of the sieve dements 8 corresponds in all figures basically to the arrangement according to FIG. 1 to provide, whenever possible, an uninterrupted total sieve surface).

As follows from FIG. 6, the lowest point 20 of the section curved outward 13 and the lowest points 21 of the section curved inward 14 lie preferably on opposite sides of an imaginary extension 16 of the section running straight 15, which follows the section curved inward 14 in conveying direction F. It is additionally advantageous if the gap Al identified in FIG. 7 between the two lowest points 20, 21 corresponds to the height H of the filter elements or the gap A2 between two adjacent guiding rollers 19, described in more detail below with reference to FIG. 9.

In addition, FIG. 8 shows that it can be sufficient in an embodiment of the invention if the guiding track 12 of the drive dements 4 (which preferably exist in the form of drive chains 18) comprises merely one section curved outward 13 downstream from the upper redirecting area 6. In other words, under certain circumstances, an additional section curved inward 14 can be dispensed under certain circumstances. The corresponding guiding track 12 follows from FIG. 8. Furthermore, it can be exemplarily gathered from this figure for all embodiments that the rotational direction D of a cleaning brush 23 executed as part of the cleaning device 10 is preferably selected in such a way while the sieve device is operating, that the outward-facing brush sections 25 making contact with the sieve surfaces 9 go past them moving in a direction opposite the conveying direction F of the sieve surfaces 9 mentioned above. As a result of this, the relative movement between the corresponding brush sections 25 and the sieve surfaces 9 to be cleaned is increased with respect to an opposite rotational movement D, and cleaning improves as a result of this.

Finally, FIG. 9 shows a possible guidance of the sieve elements 8 (not shown) in the area of the upper redirecting area 6. Both sides of the sieve elements 8 are connected in each case to a guiding chain (only one of them shown in FIG. 9) and guided into an upper redirecting section 26 with the help of an upper gear wheel 30 (the second drive chain 18 runs along a plane parallel to the sheet plane and a plane arranged above the sheet plane, wherein the corresponding sieve elements 8 extend perpendicularly between the two drive chains 18). The drive chain 18, in turn, has individual guiding rollers 19 in the area of the joints and they are preferably arranged on the side facing away from the sieve elements 8 (i.e. looking at FIG. 9, behind the drive chain 18).

So the guiding rollers 19—and with them, the sieve elements 8 on the guiding track 12 shown in FIG. 5—can be guided, the sieve device has, at least in the upper redirecting area 6, one or several guiding elements 11 in which the guiding rollers 19 are guided, especially in the area of the section pointing outward and in the area of the section pointing inward of the guiding track 12. Here, the mutual gap A3 of adjacent guiding surfaces 22 is only slightly larger (e.g. no more than 10% to 20%) than the diameter of the guiding rollers 19 to ensure, as far as possible, a low-play guidance of the guiding rollers 19. However, some play should in any case be provided so the guiding rollers 19 can be rotated between the adjacent guiding surfaces 22.

This invention is not limited to the embodiments shown and described. Variations within the scope of the patent claims are just as possible as a combination of the characteristics mentioned in the description or in the patent claims, even if they are shown and described in different embodiments.

### LIST OF REFERENCE SIGNS

1 impurity

2 Sewage

3 Drive

4 Drive element

5 Lower redirecting area

6 Upper redirecting area

7 Ejection device

8 Sieve element

9 Siece surface

10 Cleaning device

11 Guiding element

12 Guiding track

13 Section curved outward

14 Section curved inward

15 Section running straight

16 Extension of the section running straight

17 Spray nozzle

18 Drive chain

19 Guiding roller

20 Lowest point of the arch of the section curved outward

21 Lowest point of the arch of the section curved inward

22 Guiding surface

23 Cleaning brush

24 Rotating axis

25 Bristle section pointing outward

26 Redirecting section

27 Brush drive

28 Carrier structure

29 Sewer

30 Upper gear wheel

31 Lower gear wheel

32 Cleaning rake

33 Seal

34 Valley

35 Mountain

A1 Gap between the lowest point of the arch of the section curved outward and the lowest point of the arch of the section curved inward

A2 Gap between two adjacent guiding rollers in conveying direction

A3 Mutual gap between two adjacent guiding elements

H Height of the filter elements

F Conveying direction

D Rotating direction

1. Sieve device for separating and removing impurities (1) from sewage (2)
with at least two endless drive elements (4) running parallel to one another that can be driven with the help of a drive (3) in a conveying direction (F),
wherein the drive elements (4) are in each case guided over a lower redirecting area (5) and an upper redirecting area (6) on an orbit,
wherein multiple sieve elements (8) extend, arranged adjacently from one another, between the drive elements (4) and sieve elements (8) connected to the drive elements (4),
wherein at least most of the sieve elements (8) have in each case a sieve surface (9) curved outward in a side view of the sieve device, and
wherein the sieve device has a cleaning device (10) arranged downstream from the upper redirecting area (6) in conveying direction (F) that can be passed by the sieve elements (8) while they move along the orbit mentioned above, and that is executed to remove the impurities (1) of the sieve surfaces (9) of the sieve elements (8) that are held back by the sieve elements (8),
characterized in that,
the drive elements (4) and/or the sieve elements (8) are guided in each case on a guiding track (12) in the area of the cleaning device (10) with the help of guiding elements (11), in which case the guiding track (12) has, in the above-mentioned side view in the area of the cleaning device (10), a section curved outward (13), i.e. towards the cleaning device (10).

2-13. (canceled)
